(19) United States
(12) Patent Application Publication
(10) Pub. No.: US 2004/0258942 A1
(43) Pub. Date: Dec. 23, 2004

(54) Digitally printable coated sheet and method of making same

(76) Inventors: Hugh Neville Glenister, Sunninghill (ZA); Norbert Nibbrig, Aachen (DE)

Correspondence Address: Milbank, Tweed, Hadley & McCloy, LLP, International Square Building, Suite 1100, 1825 Eye Street, Washington, DC, 20006--541, US

(21) Appl. No.: 10/843,531

(22) Filed: May 12, 2004

(30) Foreign Application Priority Data
May 13, 2003 (DE) 103 21 365.1

(51) Int. Cl. B29D 23/00

(52) U.S. Cl. 428/537.5; 428/521

(57) ABSTRACT

The invention is directed to a coated sheet comprising a substrate selected from the group consisting of plastic film, paper and paper-like material that can be imprinted using digital printing technology, especially self-adhesive coated sheets that are provided on their reverse side with an adhesive coating and a siliconized covering, whereby the surface of the substrate is coated with a thin film of acrylate polymer. Methods of making a coated sheet and methods of printing using a coated sheet are also disclosed.

This Application claims priority under 35 U.S.C. § 119(a) to German Patent Application 103 21 365.1, filed May 13, 2003. All patents, patent applications and publications cited herein are incorporated by reference in their entirety.

### FIELD OF THE INVENTION

The invention relates to digitally printable coated sheets made from a substrate selected from the group consisting of plastic film, paper and paper-like material. The coated sheet can be imprinted using digital printing technology and is coated on at least one side with acrylate polymer. The substrate is preferably self-adhesive plastic film or paper or paper-like material that has on its reverse side an adhesive coating and a siliconized covering. The invention also relates to methods of making the coated product from paper or paper-like material or plastic (film) and printing methods.

### BACKGROUND OF THE INVENTION

In addition to previous printing technologies like letterpress, rotogravure and silkscreen, digital printing technology is becoming more and more widespread. In digital printing technology, the printing colors, mainly designated as printing ink, are transferred directly to the substrate under computer-control using the finest possible spraying technique. If the substrate is a type of paper, no particular problems occur. However, an unsatisfactory print image occurs if a film consisting of plastic, in particular polyvinyl chloride (PVC), is used as the substrate. In this case, print quality may be improved if printing inks are used that contain volatile organic solvents. However, this has the disadvantage that the film can be damaged and its surface will lose its strength. In addition, the printers that are used for this must be provided with a solvent suction system, which increases the costs for the printer as well as for the printing itself.

In one aspect of the invention, Applicants have surprisingly found that the problem of unsatisfactory print images when plastic films are used as the substrate for printing may be solved by applying a thin film of a polymer substance, in a preferred embodiment, an acrylate polymer, to a plastic film. The resultant plastic film yields superior images after processing using a digital printing device.

### SUMMARY OF THE INVENTION

The invention is based on the object of producing a coated sheet comprising a substrate selected from the group consisting of plastic film, paper and paper-like material that can be imprinted with digital technology and can be printed with ink that is harmless to health and environmentally safe and which produces a satisfactory print image. The invention is also directed to methods for producing a coated sheet in a digital printing process and to methods of printing.

In one embodiment, the invention is directed to a coated sheet comprising a substrate selected from the group consisting of plastic film, paper and paper-like material that is imprintable by a digital printing device, wherein at least one surface of the substrate is coated with a thin film of a polymer coating comprising an acrylate polymer. Any plastic film may serve as the substrate. Preferably, the plastic film is made from polyvinyl chloride (PVC), polyester (PET), polypropylene (PP), polyethylene (PE) or polyurethane (PU) or any combination of these materials.

In a preferred embodiment, the coated sheet comprising a substrate selected from the group consisting of plastic film, paper and paper-like material of the invention, is characterized in that the top surface of the substrate is coated with a thin film of a polymer coating comprising an acrylate polymer and the bottom surface of the substrate comprises a self-adhesive coating and a siliconized covering. In one embodiment, the siliconized covering may be peeled off of the plastic film or paper or paper-like material after printing. The siliconized covering may be made of plastic, paper, or foil or any combination of these materials.

In another embodiment of the invention, the coated sheet comprising a substrate selected from the group consisting of plastic film, paper and paper-like material is characterized in that the acrylate polymer is a copolymer of butyl acrylate and methyl methacrylate.

In a preferred embodiment of the invention, the coated sheet comprising a substrate selected from the group consisting of plastic film, paper and paper-like material is further characterized in that the acrylate copolymer is about 50% by weight butyl acrylate and about 50% by weight methyl methacrylate.

In one aspect of the invention, the coated sheet comprising a substrate selected from the group consisting of plastic film, paper and paper-like material is characterized in that the polymer coating is highly transparent. In a preferred embodiment of the invention, the plastic film is a high-gloss film.

The invention is also directed to methods of making a coated sheet comprising a substrate selected from the group consisting of plastic film, paper and paper-like material that is imprintable by a digital printing device, wherein the method comprises the step of coating at least one surface of the substrate with a thin film of a polymer coating, wherein the polymer coating comprises an acrylate polymer and the thin film is coated onto the substrate before printing.

In an embodiment of the invention, the method of making a coated sheet comprising a substrate selected from the group consisting of plastic film, paper and paper-like material is further characterized in that the thin film of a polymer coating is applied to the top surface of the substrate and a self-adhesive coating and a siliconized covering over the self-adhesive coating are applied to the bottom surface of the substrate.

In one embodiment of the method for making a coated sheet comprising a substrate selected from the group consisting of plastic film, paper and paper-like material, the acrylate polymer is applied to the surface of the substrate as an aqueous dispersion. A further embodiment of the method comprises the step of drying at about 90° C. to about 100° C. after applying the acrylate polymer to the surface of the substrate. Preferably, drying is done at about 90° C., about 91° C., about 92° C., about 93° C., about 94° C., about 95° C., about 96° C., about 97° C., about 98° C., about 99° C., or about 100° C. In a still further embodiment, the method of the invention is characterized in that the printing process uses pigmented ink. In certain embodiments, the pigmented ink is based on lactic acid or lactic acid derivatives.

In certain embodiments, drying time may be about 5, about 10, about 15, about 20, about 25, about 30, about 35, about 40, about 45, about 50, about 55, about 60, about 65, about 70, about 75, about 80, about 85, about 90, about 95, about 100, about 105, about 110, about 115, about 120, about 125, about 130, about 135, about 140, about 145, about 150, about 155, about 160, about 165, about 170, about 175 or about 180 seconds.

A preferred embodiment of the invention includes a coated sheet comprising a substrate selected from the group consisting of plastic film, paper and paper-like material made by any one of the methods herein disclosed.

A still further aspect of the invention is directed to a method of printing with a digital printing device to create a printed image on a coated sheet comprising a substrate selected from the group consisting of plastic film, paper and paper-like material comprising the step of contacting a coated sheet with a digital printing device, wherein at least one surface of the substrate is coated with a thin film of a polymer coating comprising an acrylate polymer.

In a preferred embodiment of the disclosed printing method, the top surface of the substrate is coated with a thin film of a polymer coating comprising an acrylate polymer and the bottom surface of the substrate comprises a self-adhesive coating and a siliconized covering.

In a still further embodiment of the disclosed printing method, the acrylate polymer is a copolymer of butyl acrylate and methyl methacrylate. Preferably, the copolymer is about 50% by weight butyl acrylate and about 50% by weight methyl methacrylate. In one embodiment, the polymer coating is highly transparent. In a still further embodiment, the plastic film is a high-gloss film.

### DETAILED DESCRIPTION OF THE INVENTION

In one aspect of the invention, in order to achieve a satisfactory print image on a coated sheet comprising a substrate selected from the group consisting of plastic film, paper and paper-like material, the surface of the substrate is coated with a thin film of an acrylate polymer. General methods for coating or printing plastic foils or films are described, for example, in U.S. Pat. No. 5,552,183. Thin films are described generally, for example, in U.S. Pat. Nos. 4,656,963 and 4,605,574. This results in a highly transparent and high-gloss polymer coating. In a preferred embodiment, a copolymer of butyl acrylate and a methyl methacrylate is used as the acrylate polymer. The percentages of the copolymer are preferably about 50% by weight butyl acrylate and about 50% by weight methyl methacrylate. As used herein, copolymers are polymers that are produced by polymerizing two or more substances (monomers) together. As used herein, paper-like materials include sheets made from vegetable or synthetic fibers or other synthetic constituents.

In other embodiments, the percentage by weight of butyl acrylate in the copolymer may be about 10%, about 15%, about 20%, about 25%, about 30%, about 35%, about 40%, about 45%, about 50%, about 55%, about 60%, about 65%, about 70%, about 75%, about 80%, about 85% about 90% or about 95%. The percentage by weight of methyl methacrylate in the copolymer may be about 10%, about 15%, about 20%, about 25%, about 30%, about 35%, about 40%, about 45%, about 50%, about 55%, about 60%, about 65%, about 70%, about 75%, about 80%, about 85% about 90% or about 95%.

Other acrylate monomers in the amounts recited above may be used to make the acrylate copolymer. In certain embodiments, the acrylate polymer of the present invention may comprise a homo- or copolymer. The resulting polymer product may also exhibit pressure sensitive adhesive properties.

In a further embodiment, the acrylate polymer comprises the reaction product of at least one acrylate A monomer and optionally a B monomer different from said A monomer.

For example, the at least one A monomer may comprise a monomeric (meth)acrylic acid ester of a non-tertiary alcohol where the alcohol portion has from 1 to 30 carbon atoms. Exemplary A monomers include but are not limited to esters of acrylic acid or methacrylic acid with non-tertiary alcohols such as 1-butanol, 1-pentanol, 2-pentanol, 3-pentanol, 2-methyl-1-butanol, 1-methyl-1-pentanol, 2-methyl-1-pentanol, 3-methyl-1-pentanol, 2-ethyl-1-butanol, 3,5,5-trimethyl-1-hexanol, 3-heptanol, 2-octanol, 1-decanol, 1-dodecanol, etc. Exemplary A monomers formed from an alcohol having at least 12 carbon atoms include but are not limited to lauryl acrylate (C₁₂), tridecylacrylate (C₁₃), myristyl acrylate (C₁₄), palmityl acrylate (C₁₆) and stearyl acrylate (C₁₈).

One or more optional polymerizable B monomers different from the A monomer may be incorporated in the copolymer which B monomer(s) is copolymerizable with the A monomer. Such additional B monomer(s) may be either hydrophilic or hydrophobic.

Exemplary optional B monomers include vinyl monomers having at least one nitrogen atom. Such monomers include but are not limited to N-mono-substituted acrylamides such as acrylamide, methacrylamide, N-methylacrylamide, N-ethylacrylamide, N-methylolacrylamide, N-hydroxyethylacrylamide, and diacetone acrylamide; N,N-disubstituted acrylamides such as N,N-dimethylacrylamide, N,N-diethylacrylamide, N-ethyl-N-aminoethyl acrylamide, N-ethyl-N-hydroxyethylacrylamide, N,N-dimethylolacrylamide, and N,N-dihydroxyethylacrylamide, etc. Other optional B monomers may include, for example, various vinyl monomers such as (meth)acrylic acid, itacoriic acid, crotonic acid, methoxyethyl (meth)acrylate, ethyoxyethyl (meth)acrylate, glycerol (meth)acrylate, hydroxyethyl methacrylate; hydroxypropyl methacrylate, beta-carboxyethyl acrylate, vinyl pyrrolidone, vinyl caprolactam and caprolactam acrylate. One or more B monomers may be employed.

It has been shown that such a coated sheet comprising a substrate selected from the group consisting of plastic film, paper and paper-like material can be printed very well with low-solvent printing ink in digital printing technology. This has the advantage of creating images in which no running of the printing inks occurs and no other printing errors occur.

The acrylate polymers of the invention may be made using techniques employed in the polymer arts. In a preferred embodiment, it is increasingly becoming desirable to avoid the use of a solvent in the production of polymers. Environmental concerns as well as the need to produce residual solvent-free products may necessitate the use of solvent-free reaction mixtures in polymerization reactions. It is known to form an acrylate polymer by free radical polymerization in the presence of a diluent such as toluene, hexane, pentane, acetone, methyl ethyl ketone, methanol, t-butyl alcohol, and isopropanol. See, for example, U.S. Pat. No. 4,619,979. Other, more environmentally safe methods are known for the production of acrylate polymers. See for example, U.S. Pat. No. 6,566,466.

Digital printing devices and methods are known in the printing arts and are generally described, for example, in U.S. Pat. Nos. 6,608,986; 6,529,288; 6,539,858; 5,819,667; 5,777,576.

In one embodiment of the invention, in order to obtain a coated sheet comprising a substrate selected from the group consisting of plastic film, paper and paper-like material that is properly printed in digital printing, the surface of the film or paper or paper-like material is coated with a thin film of an acrylate polymer before the printing process. To do this, the acrylate polymer is applied as an aqueous dispersion on the surface of the film or paper or paper-like material and then dried at a temperature of about 90° C. to about 100° C. Higher temperatures can lead to damage of the decorative film. At temperatures that are too low, the copolymer is not hardened adequately. Application of the polymer to the film or paper or paper-like material can be carried out in the gravure system, which is followed by drying.

The gravure system used in printing is generally described in U.S. Pat. Nos. 6,598,523 and 6,119,595. In the gravure system, the dispersion is applied to the film strip or paper or paper-like material using a rotating metal cylinder with an engraved structure on its surface. The dried coating is not adhesive, so the film or paper or paper-like material can be rolled into a roll in the usual way. For the printing process, the film or paper or paper-like material is fed to a digital printer that works with low-solvent printing ink and carries out the printing process. It has been found that a very good print image can be printed and the film or paper or paper-like material also has a surface with high resistance. Preferably, printing inks based on pigments are used. In certain embodiments, the pigments may be based on lactic acid. These printing inks can be processed very well on a film or paper or paper-like material provided with the acrylate coating. In this case, it is a printing ink with not easily volatized organic solvents. In certain embodiments, the ink may comprise an organic base, for example, a lactate base. The inks are designated as low-volatile solvent ink, low-solvent ink, eco-solvent ink and mild-solvent ink. Environmentally friendly inks are described generally, for example, in U.S. Pat. No. 6,648,951. Inks employing lactic acids are described generally, for example, in U.S. Pat. No. 6,676,737. Siliconized release liners and siliconized coverings and paper are described generally in U.S. Pat. Nos. 6,238,762; 6,673,408; 6,586,510; 5,552,451; 6,620,870; and 6,511,744.

The description of the present invention has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated. The following examples illustrate embodiments of the invention and are in no way intended to limit the scope of the invention.

### EXAMPLE I

A decorative film which comprises a PVC film that is provided on its reverse side with an adhesive coating and a siliconized paper covering, is fed to a gravure device and coated there with a thin film of an aqueous dispersion of a copolymer of butyl acrylate and methyl methacrylate. The PVC film is transparent, or colored white during its manufacture, in order to form a good printing substrate. It is also possible to use film colored with a different color if this is useful for the later printing process. After coating, the decorative film is dried at about 96° C. in a through-type oven located downstream from the gravure device. The drying time is about 30 seconds. The dried decorative film is fed to a digital printer and printed there with the use of a low-solvent printing ink. An excellent print image is achieved on an extremely stable surface. The process is especially suitable for producing photo-realistic printing.

### EXAMPLE II

A PVC film coated on one side with a thin film of an acrylate polymer comprising about 50% by weight butyl acrylate and about 50% by weight methyl methacrylate is prepared by contacting a PVC film with an aqueous dispersion of the acrylate polymer. After coating, the PVC film is dried at about 95° C. for about 25 seconds. On the reverse side of the coated PVC film, an adhesive composition is applied to create a self-adhesive film. Over the self-adhesive a siliconized layer of paper is applied to the adhesive coating. The coated PVC film is loaded into a digital printer to form images on the side of the PVC film that has the thin film of acrylate polymer.

Other embodiments of the invention will be apparent to those skilled in the art from a consideration of this specification or practice of the invention disclosed herein. It is intended that the specification and example be considered as exemplary only, with the true scope and spirit of the invention being indicated by the following claims.

What is claimed is:

1. A coated sheet for digital printing comprising:
a) a substrate selected from the group consisting of plastic film, paper and paper-like material; and
b) a coating comprising a thin film of acrylate polymer on at least one surface of said substrate.

2. The coated sheet of claim 1, wherein the top surface of said substrate is coated with a thin film of a polymer coating comprising an acrylate polymer and the bottom surface of said substrate comprises a self-adhesive coating and a siliconized covering.

3. The coated sheet of claim 1, wherein the acrylate polymer is a copolymer of butyl acrylate and methyl methacrylate.

4. The coated sheet of claim 3, wherein the copolymer is about 50% by weight butyl acrylate and about 50% by weight methyl methacrylate.

5. The coated sheet of claim 1, wherein the polymer coating is highly transparent.

6. The coated sheet of claim 1, wherein said plastic film is a high-gloss film.

7. A method of making a coated sheet comprising a substrate selected from the group consisting of plastic film, paper and paper-like material, that is imprintable by a digital printing device, wherein the method comprises the step of coating at least one surface of the substrate with a thin film comprising acrylate polymer and the thin film is coated onto the substrate before printing to thereby make a coated sheet.

8. The method of claim 7, wherein the acrylate polymer is applied to the top surface of the substrate and a self-adhesive coating and a siliconized covering are applied to the bottom surface of the substrate.

9. The method of claim 7, wherein the acrylate polymer is applied to the surface of the substrate as an aqueous dispersion.

10. The method of claim 7 further comprising the step of drying at about 90° C. to about 100° C. after applying the acrylate polymer to the surface of the substrate.

11. The method of claim 10, wherein the drying time is about 30 seconds.

12. The method of claim 7, wherein said printing is a printing process with pigmented ink.

13. The method of claim 12, wherein said pigmented ink is based on lactic acid or lactic acid derivatives.

14. A coated sheet made by any one of the methods of claims 7-13.

15. A method of printing with a digital printing device to create a printed image on a coated sheet comprising a substrate selected from the group consisting of plastic film, paper and paper-like material, said method comprising the step of contacting the coated sheet with a digital printing device, wherein at least one surface of the substrate is coated with a thin film comprising acrylate polymer.

16. The method of claim 15, wherein the top surface of the substrate is coated with a thin film of a polymer coating comprising an acrylate polymer and the bottom surface of said substrate comprises a self-adhesive coating and a siliconized covering.

17. The method of claim 15, wherein the acrylate polymer is a copolymer of butyl acrylate and methyl methacrylate.

18. The method of claim 17, wherein the copolymer is about 50% by weight butyl acrylate and about 50% by weight methyl methacrylate.

19. The method of claim 15, wherein the polymer coating is highly transparent.

20. The method of claim 15, wherein said plastic film is a high-gloss film.

21. The method of claim 15, wherein said printing is a printing process with pigmented ink.

22. The method of claim 21, wherein said pigmented ink is based on lactic acid or lactic acid derivatives.
